(19) United States
(12) Patent Application Publication
(10) Pub. No.: US 2025/0131283 A1
(43) Pub. Date: Apr. 24, 2025

(54) TRANSFER LEARNING FOR CASCADED EDFA MODELS ERROR ACCUMULATIONS IN A MULTI-SPAN SYSTEM

(71) Applicant: NEC Laboratories America, Inc., Princeton, NJ (US)

(72) Inventors: Yue-Kai Huang, Princeton, NJ (US); Zehao Wang, Durham, NC (US)

(73) Assignee: NEC Laboratories America, Inc., Princeton, NJ (US)

(21) Appl. No.: 18/901,798

(22) Filed: Sep. 30, 2024

Related U.S. Application Data
(60) Provisional application No. 63/591,632, filed on Oct. 19, 2023.

(51) Int. Cl. G06N 3/096; G06N 3/067

(52) U.S. Cl. CPC G06N 3/096; G06N 3/067

(57) ABSTRACT

Disclosed are systems and methods directed to transfer learning of cascaded EDFA models error accumulations in a multi-span system in which a two-step method using transfer learning is employed to reduce EDFA model error accumulation in a multi-span system. A first step of employs existing pretrained component-level ML-based EDFA models in chain to create a large synthetic dataset. The synthetic dataset includes all related features and labels for a specific end-to-end link. A source model is trained based on the large synthetic dataset. To accommodate a performance prediction gap between real link condition and the source model, which is trained on synthetic dataset, our method employs a second step that collects a few measurements from the real end-to-end link and makes few-shots learning to transfer the synthesis-data-based source model to real-data-based target model.

### CROSS-REFERENCE TO RELATED APPLICATIONS

This application claims the benefit of U.S. Provisional Patent Application Ser. No. 63/591,632 filed Oct. 19, 2023, the entire contents of which is incorporated by reference as if set forth at length herein.

### FIELD OF THE INVENTION

This application relates generally to Erbium-doped fiber amplifiers (EDFAs) for optical communications. More particularly, it pertains to transfer learning for cascaded EDFA models error accumulations in a multi-span system.

### BACKGROUND OF THE INVENTION

Erbium-doped fiber amplifiers (EDFAs) are the most-commonly used commercial optical amplifier and they impact end-to-end system performance of optical transmission systems such as optical signal-to-noise ratio (OSNR) and quality of transmission (QoT). The gain characterization of an EDFA is challenging as it depends on many factors such as internal hardware architecture, gain setting, channel-loading configuration, and input power levels.

Recently, machine learning-based (ML) EDFA models for wavelength-dependent gain exhibiting a high prediction accuracy on a single EDFA device have been proposed by researchers. However, for an optical link with multiple cascaded EDFAs, prediction errors contributed by individual EDFA models accumulate as the number of EDFA devices increase. For example, the predicted mean absolute error across 10 EDFAs reaches 0.8-dB with a maximum absolute error of around 4.0-dB in recent literature.

### SUMMARY OF THE INVENTION

An advance in the art is made according to aspects of the present disclosure directed to transfer learning of cascaded EDFA models error accumulations in a multi-span system.

In sharp contrast to the prior art and according to aspects of the present disclosure, we now disclose a two-step method using transfer learning to reduce EDFA model error accumulation in a multi-span system.

As we shall describe further, the first step of our inventive method employs existing pretrained component-level ML-based EDFA models in chain to create a large synthetic dataset. The synthetic dataset includes all related features and labels for a specific end-to-end link.

A source model is trained based on the large synthetic dataset. To accommodate a performance prediction gap between real link condition and the source model which is trained on synthetic dataset, our inventive method employs a second step that collects a few measurements from the real end-to-end link and makes few-shots learning to transfer the synthesis-data-based source model to real-data-based target model.

### BRIEF DESCRIPTION OF THE DRAWING

FIG. 1 is a schematic diagram showing an illustrative pipeline using component-level EDFA models and a few-shot end-to-end measurement to train an end-to-end model according to aspects of the present disclosure.

FIG. 2 is a schematic diagrams showing an illustrative EDFA model architecture according to aspects of the present disclosure.

FIG. 3 is a schematic diagram showing an illustrative pipeline using pretrained EDFA models to generate end-to-end synthesis dataset according to aspects of the present disclosure.

FIG. 4 is a schematic block diagram showing illustrative features of our inventive method according to aspects of the present disclosure.

FIG. 5 is a schematic diagram showing an illustrative experimental setup for simultaneous data transmission and link monitoring using BOTDA for a hybrid-fiber link according to aspects of the present disclosure.

FIG. 6 is a schematic diagram showing an illustrative model merging diagram for 1 span according to aspects of the present disclosure.

FIG. 7 shows in tabular form fiber length for different end-to-end links, in which italic numbers represent field fibers, according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

As noted previously, we disclose a two-steps method using transfer learning to reduce the EDFA model error accumulation in a multi-span system. The first step uses existing, pretrained component-level ML-based EDFA models in chain to create a large synthetic dataset. The synthetic dataset includes all related features and labels for a specific end-to-end link.

A source model is trained based on the large synthetic dataset. To handle the performance prediction gap between real link condition and the source model, which is trained on synthetic dataset, we employed a second step is collecting a few measurements from the real end-to-end link and making few-shots learning to transfer the synthesis-data-based source model to real-data-based target model

While there is always a debate among those skilled in the art with respect to a digital twin system namely, which one is better between a component-level model or an end-to-end model. For a component-level model, it is easy to measure and applied to all different topologies. The drawback of component-level model is the error will accumulate when the number of components becomes larger.

However, for the end-to-end model, the accuracy remains high whenever the number of components is larger. As for end-to-end model, operators must redo full-scale measurements on the link every time the topology is changed.

Our inventive method fills the gap between the component-level models and end-to-end models, which applies to different topologies just with a few numbers of measurements.

Our first inventive feature is we use existing individual EDFA models to generate the dataset, which fully uses the existing knowledge inside the component-level model and can be applied to any topology. Our second inventive feature is to use transfer learning to compensate the accumulated error by feeding the model with a few real end-to-end measurements.

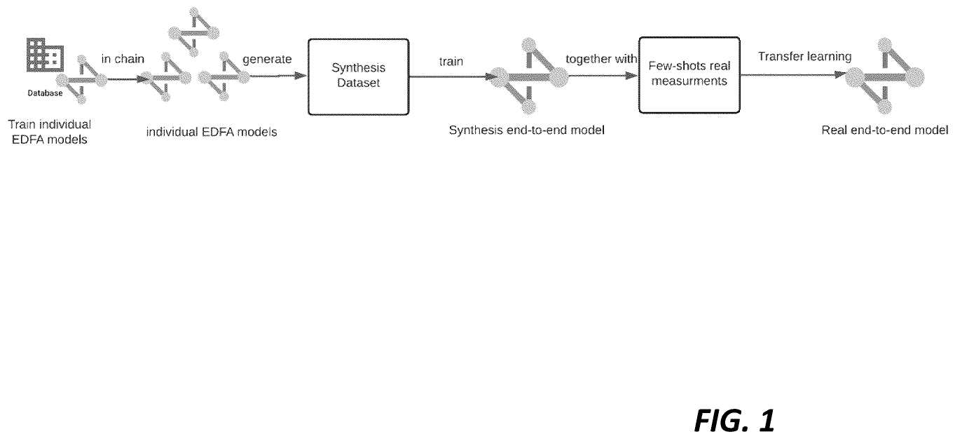

FIG. 1 is a schematic diagram showing an illustrative pipeline using component-level EDFA models and a few-shots end-to-end measurement to train an end-to-end model according to aspects of the present disclosure.

As those skilled in the art will understand and appreciate, few-shots end-to-end measurement is a technique in machine learning where a model is trained on a limited dataset and is then expected to perform well on new, unseen data. This approach is particularly useful when data is scarce or expensive to obtain. Few-shots exhibits a number of key components.

Few-Shot Learning: This involves training a model with only a few examples of each class. The goal is to enable the model to generalize to unseen data from those limited examples.

End-to-End Measurement: This refers to the process of directly measuring the desired output from the input without intermediate steps. In the context of few-shot learning, it means the model can directly predict the class or category of a new image without requiring additional feature extraction or intermediate representations.

Few-shot learning has been applied to a number of applications.
Image Classification: Identifying objects in images with limited training data.
Natural Language Processing: Understanding and generating text with few examples.
Medical Image Analysis: Diagnosing diseases from medical images with limited patient data.

Techniques employed with few-shot learning include the following.
Meta-Learning: Training a model to learn how to learn from few examples. This involves training on multiple tasks with limited data each.
Metric Learning: Learning a distance metric between examples that can be used to classify new data.
Data Augmentation: Creating new training data from existing examples to increase the effective size of the dataset.

Benefits of few-shot learning include the following.
Efficiency: Requires less data, making it suitable for scenarios where data collection is expensive or time-consuming.
Flexibility: Can be applied to various domains and tasks.
Generalization: Models trained with few-shot learning can often generalize well to unseen data, demonstrating their ability to learn from limited information.

In essence, few-shots end-to-end measurement offers a promising approach for building machine learning models that can perform well with limited data, making it a valuable tool in various applications.

As noted, one aspect of the present disclosure is to provide a solution to error accumulation for multi-span optical system resulting from component-level EDFA models in chain. Instead of passive end-to-end model, this method can dynamically adapt to different topologies, just from a few measurements from the new topology. Our method requires pretrained EDFA models for all the EDFA devices in the optical link, which is measured once and can be applied to all topologies.

There are five detailed steps for this method to train a real end-to-end model with a few measurements from the link, as shown illustratively in FIG. 1. We note that Step 1 is optional if the individual EDFA model has already been measured and trained.

After comprehensive measurements of the EDFA gain profile and training individual models for each EDFA devices, step 2 is executed and uses these models in chain to generate a synthetic dataset to simulate the optical link. This step can be performed to use either raw codes or optical system simulators such as GNPy or mininet-optical. The synthetic dataset shall have all different channel loadings and input power levels to obtain a large source space for a step 3, new end-to-end model training.

In step 3, the new model is trained from scratch by the step 2 large synthetic dataset. After the model coverage, we can assume the model an accurate presentation of the simulated end-to-end optical link model based on the individual component descriptions, however it is not accurate enough to provide prediction for the real-link performance due to error accumulation.

Therefore, a small number of newly collected measurements from the real link are used for guiding the model transferred from simulated link to real link. The real measurements in step 4 can be collected using a built-in optical channel monitor (OCM) or additional optical spectra analyzer (OSA). The new collect data is split into training set and test set.

In step 5, a typical two step transfer learning is performed on the synthesized model using the step 4 training set data: 1) adding a few layers at the output layers and retraining with all original layers frozen; and 2) unfrozen all layers and fine-tune the model with a few epochs. Using the step 4's test set data, we can evaluate the performance of the transferred model to check its accuracy on the real optical link

### Step 1: Train Individual EDFA Models

To train an accurate individual EDFA model, it is necessary to collect large dataset of different gain settings, input power levels, channel loading conditions to characterize the gain ripple.

As already pointed out, we can use extra optical devices like PD and OSA or use in-line PD and OCM from the ROADM device to measure the input/output total power and spectrum. With the measured power spectrum, gain profile can be extracted as target output for EDFA models, together with many other related features such as channel loading condition or gains settings to train a EDFA model.

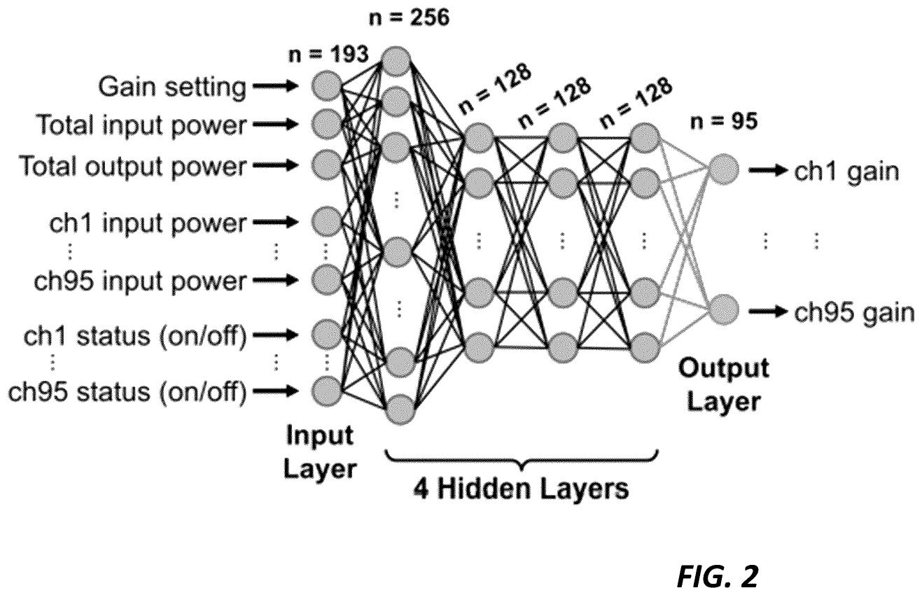

FIG. 2 is a schematic diagrams showing an illustrative EDFA model architecture according to aspects of the present disclosure.

As shown in FIG. 2, a typical EDFA model can be trained using the previously described measurement data. These individual EDFA models for each device are saved for the use of step 2.

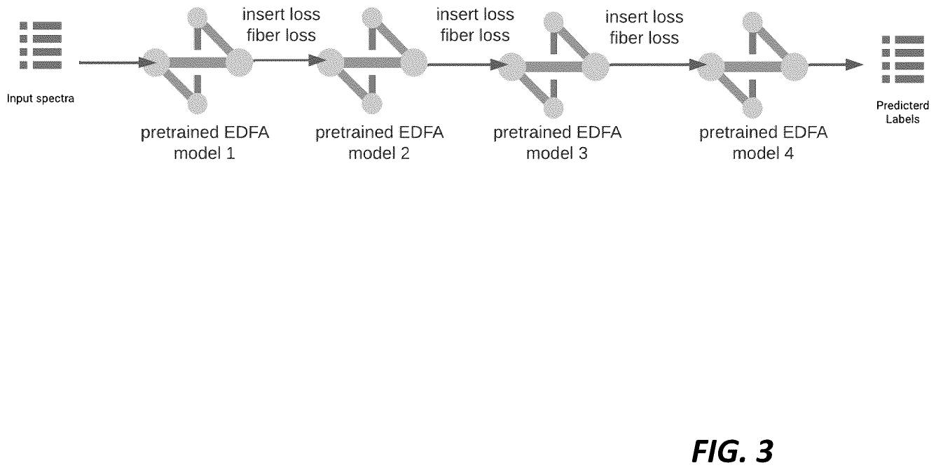

FIG. 3 is a schematic diagram showing an illustrative pipeline using pretrained EDFA models to generate end-to-end synthesis dataset according to aspects of the present disclosure.

### Step 2: Using Individual EDFA Models to Generate Large Synthetic Dataset

After step 1, we use the individual EDFA models to generate a synthetic dataset for retraining a new end-to-end model for power/OSNR prediction. Shown in FIG. 3, the pretrained EDFA models are placed in an order of the real optical link we want to model. The first EDFA model is given input of different spectrum with various channel loadings and power levels.

Before feeding the signal spectra into the next EDFA model, the measured fiber loss and insert loss are added to the signal spectra to simulate the real propagation loss. The modified spectra after the first EDFA model and loss is put into the next EDFA model for prediction again.

Subsequently, we get the predicted output spectra from the last EDFA which we take as the training label. We store all the input features such as input spectra, channel loadings, input power levels, and the predicted output power spectra into data files. Using this method, a large synthetic dataset is generated for a specific optical link.

### Step 3: Train a New Synthesis End-to-End Model Based on the Large Synthetic Dataset

After step 2, a large synthesis end-to-end dataset with all the features and labels needed for a machine learning-based model training. In this step, we train a new end-to-end model like that shown in FIG. 1, but with more layers to capture the complexity of more EDFA devices in the optical link. The training stops when the new end-to-end model is covering the simulated dataset.

### Step 4: A Few Measurements From Real End-to-End Link

To transfer the step 3 model from synthetic dataset to a real end-to-end optical link, this step 4 is to collect several measurements from a real link with the same features, and labels compared to the synthesis dataset in step 2. Specifically, the collected features shall include at least the input spectra, the total launch power, and channel loading conditions. The labels shall include the prediction target such as output power or the OSNR of the last span. The collected measurements are divided into two parts, one for transfer learning and another for validation or testing of the transferred end-to-end model.

### Step 5: Transfer the Synthesis Model to a Real End-to-End Model

After step 4, the few shots measurements are used to transfer the model by a standard two steps transfer learning procedure. On the first step, a few initialized layers (typically one or two) are added to the end of the step 3 synthesis model. The original layers are frozen during the training and the only new added layers are trained during this first step until the loss is covered. On the second step, all layers are unfrozen and trained with only very few epochs (typically less than 5 epochs). After the transfer learning procedure is finished, the transferred model is tested on the test set of real end-to-end optical link to validate the performance of the model.

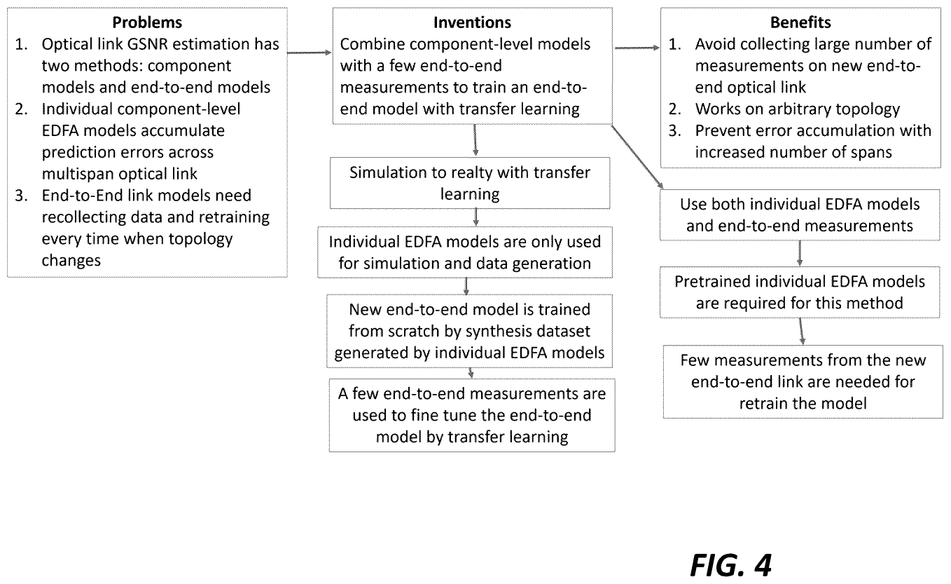

FIG. 4 is a schematic block diagram showing illustrative features of our inventive method according to aspects of the present disclosure.

### Experimental

The adaptive and scalable optical network requires automatic provisioning of optical data communication based on traffic demand, and quality of transmission (QoT) estimation is the key technology to enable that goal. Erbium-doped fiber amplifier (EDFA) is the most-commonly used commercial optical amplifier nowadays and it typically impacts end-to-end system performance such as optical signal-to-noise ratio (OSNR) which impact QoT greatly. The gain characterization of an EDFA is challenging as it depends on many factors such as internal hardware architecture, gain setting, channel-loading configuration, and input power levels.

Recently, machine learning-based (ML) EDFA models for wavelength-dependent gain are proposed by researchers with high prediction accuracy on a single EDFA device. However, for an optical link with multiple cascaded EDFAs, the prediction errors by individual EDFA models accumulate with the number of EDFA devices. For example, the predicted mean absolute error across 10 EDFAs reaches 0.8-dB with a maximum absolute error of around 4.0-dB.

Herein, we described a cascaded EDFA model learning method to combine the benefits from both pre-trained model and E2E model. We applied a two-steps method using transfer learning to reduce the EDFA model error accumulation in a multi-span system. The first step is using existing pretrained component-level ML-based EDFA models in chain to create a large synthetic dataset. The synthetic dataset consists of all related features and labels for a specific end-to-end link. A source model is trained based on the large synthetic dataset. To handle the performance prediction gap between real link condition and the source model which is trained on synthetic dataset, we employed a second step is collecting a few measurements from the real end-to-end link and making few-shots learning to transfer the synthesis-data-based source model to real-data-based target model.

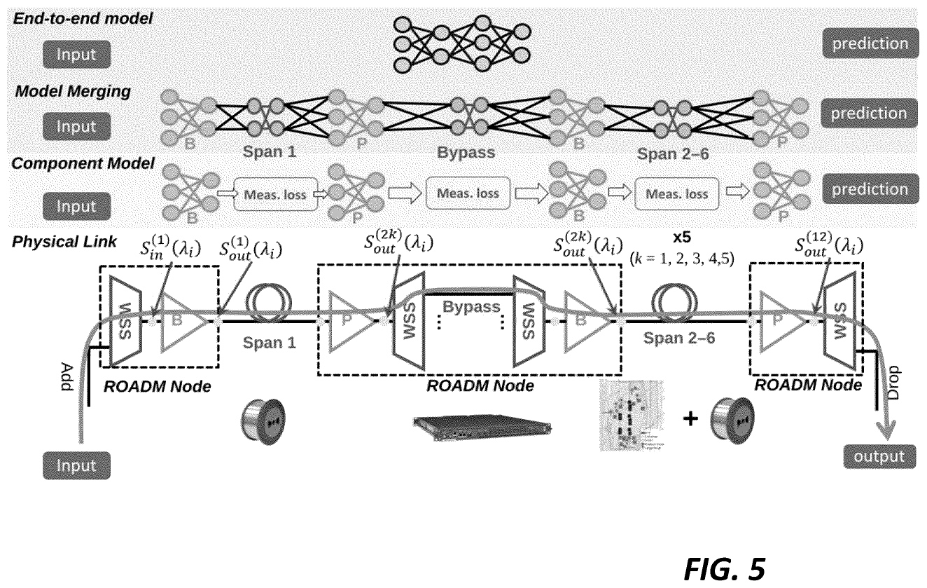

FIG. 5 is a schematic diagram showing an illustrative experimental setup for simultaneous data transmission and link monitoring using BOTDA for a hybrid-fiber link according to aspects of the present disclosure.

We have described a cascaded EDFA model learning method to solve the component-level EDFA model error accumulation issue on multi-span topologies. The pre-trained EDFA models are connected in the same order as the physical link, with three fully connected layers between each two EDFA models to compensate for the fiber loss and insert loss (See FIG. 5).

The middle three fully connected (FC) layers have 95 neurons each, with an ELU activation function for the first layer and no activation function for the rest two layers. Particularly, on a 1-span link, the first pretrained booster EDFA model takes three types of input: input spectrum, input/output PD power, and channel loading condition. It generates the predicted output spectrum which is the input into the internal blue layers for modeling the loss. The output of the blue layers serves as the input spectrum, with measured PD power reading and channel loading status, into the next pre-trained pre-amplifier EDFA model. The model is compiled with an Adam optimizer.

The training processes for the cascaded models are similar to the two-step traditional transfer learning process. First, all the weights from the pre-trained EDFA model are frozen.

The first step only trains the newly added FC layers using end-to-end measurements (input spectrum before the first EDFA, channel loading condition, output spectrum after the last EDFA, and input/output PD power for each EDFA) with a 0.05 learning rate and 250 Epochs. After the first step, all the weights are unfrozen and fine-tuned using the same end-to-end measurements with 0.001 learning rate and 50 epochs.

In addition to the “CL-full” scaled cascaded model learning (CL-Full) which uses all pre-trained EDFAs in the physical link, we also propose a “CL-small” scaled cascaded model learning (CL-Small), which only uses the first and the last EDFA pre-trained model and 3 FC layers to manipulate all the EDFA ripples and loss all in between. The structure of CL-Small is the same as shown in FIG. 2, but is able to model more than one span (ideally an arbitrary number of spans).

Two traditional methods are also included as baselines to compare with the method described in this disclosure. Component-level EDFA models are trained based on COSMOS-EDFA dataset and directly used in power prediction without any knowledge or retraining from the new link. The end-to-end model uses the end-to end measurements to train a new model without using any COSMOS-EDFA dataset. The structure and training process of the end-to-end model is almost the same as the component-level EDFA model, except it has two additional FC layers at the end without any activation function to better regress the output power.

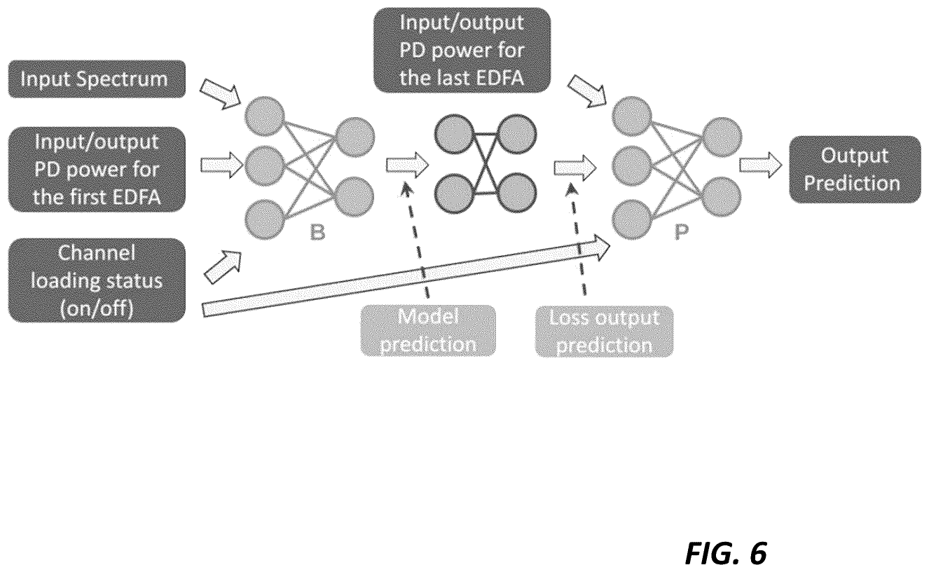

FIG. 6 is a schematic diagram showing an illustrative model merging diagram for 1 span according to aspects of the present disclosure.

The experiment is conducted in the Platforms for Advanced Wireless Research (PAWR) COSMOS Testbed, which is a city-scale optical-wireless programmable testbed located in Manhattan, New York City. In particular, it comprises a 320×320 space switch, a 16×16 switch, one customized comb source, 8 ROADMs, one dark fiber between Columbia University and 32 Avenue of the Americas, and City College of New York.

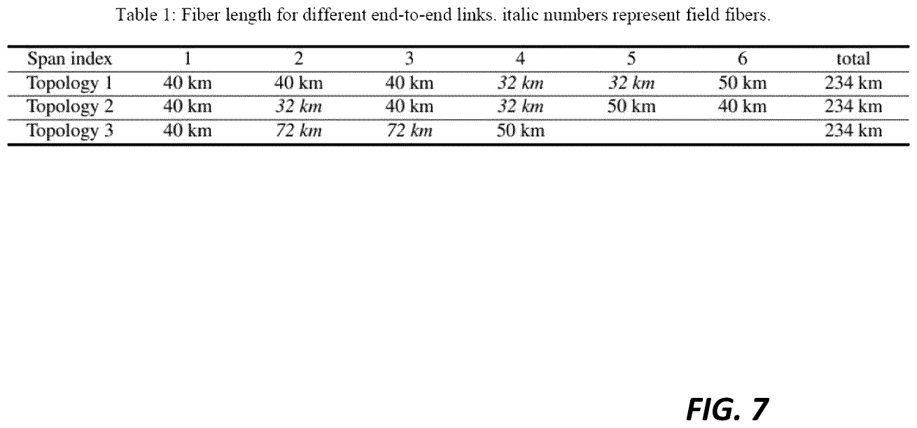

FIG. 7 shows in tabular form fiber length for different end-to-end links, in which italic numbers represent field fibers, according to aspects of the present disclosure.

We set up three topologies to verify our proposed methods: two 6-span links using 8 ROAMDs and one 4-span link using 6 ROADMs. The total fiber lengths are all 234 km containing 74 km field fiber (See FIG. 7 for details).

For each topology, we connect the comb source with 90×50 GHz in C-band to the first ROADM and use its wavelength selective switch (WSS) to load different channels and flatten the spectra S(1) in (λi) before it goes into the first EDFA. The spectra flattening is only performed once for each channel loading and the rest of the WSS apply uniform attenuations to the spectra to accumulate the EDFA gain ripples. We record the spectrum S(2k) in (λi) before and S(2k+1) in (λi) after each EDFA at k span, and the Pin input and Pout output PD power for each EDFA. All the gains for booster and preamplifier EDFA are 18 dB in high gain mode with zero tilt. After passing the last EDFA, the spectrum is dropped from the ROADM.

We have two types of channel loading conditions with different numbers of loaded channels n: i) fix condition includes the fully loaded (WDM) (with n=95), 4 half (upper/lower/oven/odd with n ∈ 47,48), 7 selected single/adjacent double (n ∈ 1,2) loaded channel conditions; ii) random condition includes 10 random channel configurations for each value of n ∈ 1,2, . . . ,94 ignoring the first channel whose power from comb source is significantly smaller than others.

### Results

We train different models based on fix channel loading and 30% random channel loading (301 measurements) and test on the rest 70% random channel loading measurements (658 measurements). To find optimized training sets for different models, we use different portions of the training set and the test set for mean absolute error (MAE) prediction. We tested on a 6-span link, we observed that both CL-Full and CL-Small exhibited good performance even trained by one fully loaded (WDM) channel measurement. Adding training set size has a small improvement on MAE for cascaded learning-based models. However, the E2E model requires a larger training set size to reach a similar level of MAE of CL-Full.

Specifically, we choose one fully loaded channel loading measurement for CL-Full and CL-Small, and 162 measurements for the E2E model for the rest of the experiments.

The MAE of different model predictions trained on different numbers of the training set after propagating n EDFAs. For example, for EDFA n=6, we treat the first three spans from the 6-span link as an end-to end system and use the input spectrum before the first EDFA and the output spectrum after 6th EDFA for training and testing models. In this way, we observed the error levels for different models on different # of spans. We observed the error of the component level EDFA model (without any knowledge from the link) accumulates when the number of EDFAs increases. E2E, CL-Small, and CL-Full models maintain similar performance after passing through different numbers of EDFAs, but the E2E model has averaged larger errors when it is only trained on 1 fully loaded measurement.

### Conclusions

At this point we have successfully demonstrated the use of cascaded learning to facilitate the modelling of component level EDFA and improved model accuracy. Our inventive technique works on arbitrary network topologies and minimizes error accumulation with increased number of EDFA compensated fiber spans. It allows the characterization of end-to-end optical gain profile with only limited number of measurements and small datasets.

While we have presented our inventive concepts and description using specific examples, our invention is not so limited. Accordingly, the scope of our invention should be considered in view of the following claims.

1. A cascaded Erbium-doped fiber amplifier (EDFA) model learning method for a multi-span optical fiber topology including a plurality of EDFAs, the method comprising:
train individual EDFA models for the plurality of EDFAs in the multi-span optical fiber topology;
generate, using the trained individual EDFA models for the plurality of EDFAs in the multi-span optical fiber topology, a synthetic dataset;
train, a new synthetic end-to-end dataset based on the generated synthetic dataset;
collect a plurality of end-to-end measurements from a real multi-span optical link having a same set of features as the multi-span optical fiber topology used to generate the new synthetic end-to-end dataset;
transfer a model of the new synthetic end-to-end dataset to a real end-to-end model of the multi-span optical fiber topology.

2. The method of claim 1 wherein the trained individual EDFA models are positioned in an order of a real optical link for which modeling is desired.

3. The method of claim 2 wherein a first EDFA model is provided an input of different spectrum with various channel loadings and power levels.

4. The method of claim 3 wherein a measured fiber loss and insert loss are added to the different spectrum before application to a next EDFA model.

5. The method of claim 4 wherein all input features including input spectra, channel loadings, input power levels and predicted output power levels are stored as data files, for generation of the synthetic dataset for a specific optical link.

6. The method of claim 5 wherein an end-to-end model of the multi-span optical topology includes more layers that capture a complexity of more EDFA devices.

7. The method of claim 6 wherein the same set of features include at least an input spectra, total launch power, and channel loading conditions.
